(19) United States
(12) Patent Application Publication
(10) Pub. No.: US 2011/0181654 A1
(43) Pub. Date: Jul. 28, 2011

(54) CUSTOMIZED WRITING INSTRUMENT AND METHOD FOR MANUFACTURING SAME

(76) Inventor: Robert Radi, La Quinta, CA (US)

(21) Appl. No.: 13/014,676

(22) Filed: Jan. 26, 2011

Related U.S. Application Data
(60) Provisional application No. 61/298,875, filed on Jan. 27, 2010.

(51) Int. Cl. B41J 2/015; B42D 15/00

(52) U.S. Cl. 347/20; 283/62

(57) ABSTRACT

The present invention provides, in at least one embodiment, a customizable writing instrument and a software technique for manufacturing such using self-adhesive pre-die cut sheets of printable paper, specialized software, standard or customized ink cartridges, and optional magnets.

### CROSS REFERENCE TO RELATED APPLICATIONS

This application claims priority under 35 U.S.C. §119(e) to U.S. Provisional Application No. 61/298,875, filed Jan. 27, 2010, and entitled “CUSTOMIZED WRITING INSTRUMENT AND METHOD FOR MANUFACTURING SAME,” the disclosure of which is hereby incorporated by reference in its entirety.

### BACKGROUND OF THE INVENTION

1. Field of Invention

The invention relates generally to writing instruments and more particularly to a customized writing instrument and technique for manufacturing such on a computer and printer.

2. Description of Related Art

Labels can be used to promote a political agenda, comment on a policy or issue, convey information, and be artistic. The labels can be printed at low cost using a commercial printing service or at home with a computer printer and self-adhesive labels. To print a label, a user often needs just a PC, printer, and internet connection or disk to download software.

Labels include stickers, tags, product labels, packaging labels, mailing labels, asset labels, and textile labels. Another example includes a piggyback label, where two layers of an adhesive substrate are combined, the bottom layer forming the backing for the top. Other labels include smart labels, which RFID chips are embedded under the label stock; asset labels are used for marking fixed and non-fixed assets; blockout labels are not see-through; radioactive labels allow tracking of chemical compounds; laser labels are designed to withstand the intense heat of laser printers and copiers; inkjet labels accept ink from an inkjet printer; security labels contain anti-counterfeiting features; and antimicrobial labels minimize the spread of infections and are used in hospitals.

U.S. Pat. No. 6,244,763 describes a method for creating a PC postage label. In the process, a postage computer program for preparing and printing the labels is provided, and information concerning the addressee, the sender, and a mail piece to be mailed and how it is to be mailed is inputted into the postage computer program. The postage computer software will interface with and direct the printer to print the label set with the postage indicia, the addressee information, and sender information, preferably in a single pass through the printer.

U.S. Pat. No. 6,246,326 describes a performance optimized smart label printer system for printing smart labels. The smart label printing system enables the expedited programming of the RFID tag component of the smart label so that delays due to the unequal time between printing the exterior of the smart label and encoding the smart label are avoided.

U.S. Pat. No. 7,588,380 describes a computer label data creating apparatus, which can make the production of label tapes faster, and increase efficiency of the production thereof. A CPU of computer equipment performs a template data create process by an editor with a display, a keyboard and the like, and the CPU creates print data composed of block information included in the template data and text data.

However, conventional methods lack creative customized features, such as the ability to create a writing instrument using a computer and printer.

### SUMMARY OF THE INVENTION

The present invention provides a customizable writing instrument and a software technique for manufacturing such using self-adhesive pre-die cut sheets of printable paper, specialized software, standard or customized ink cartridges, and optional magnets.

In an embodiment, a printed medium comprises: a printed top layer configured to receive text or images on a first side and an adhesive on a second side; a removable bottom layer, wherein the printed top layer comprises one or more die-cut shapes, each die-cut shape including a first section and a second section, wherein the first section and second section are mirror images of one another about an axis; and an opening located on the axis configured to receive an ink cartridge. The printed medium may further comprise a magnet in the printed top layer. The printed top layer may comprise announcements, invitations, promotional listings, small business advertisements, or reminding friends of good times. The printed top layer may form a two dimensional shape or a three dimensional shape, including a box, tree, or printed sleeve. An image may be printed on the printed top layer using software and a printer.

In another embodiment, a writing device comprises: an ink cartridge including a writing tip; and a folded piece of pre-cut paper covering and adhering to a portion of the ink cartridge, wherein the folded piece of paper of includes an opening along a fold line, and the writing tip protrudes through the opening. The writing device may further comprise a magnet within the folded piece of pre-cut paper. The folded piece of pre-cut paper may comprise announcements, invitations, promotional listings, small business advertisements, or reminding friends of good times. The folded piece of pre-cut paper may form a two dimensional shape or three dimensional shape, including a box, tree, or a printed sleeve. An image may be printed on the folded piece of pre-cut paper using software and a printer.

In another embodiment, a method comprises the steps of: providing an ink cartridge including a writing tip; folding a piece of pre-cut paper covering and adhering to a portion of the ink cartridge, wherein the folded piece of paper of includes an opening along a fold line; and protruding the writing tip through the opening.

An advantage of the present invention is that it allows a computer user to create customized writing instruments on a computer and printer. The finished writing instruments permit the creator or user to make a statement of individuality, use a customized writing instrument in everyday life, distribute the customized writing instruments to friends and families, trade and exchange the customized writing instruments as a social medium, create a limited number of promotional items for business or social events, and create a useful writing instrument for use in the academic environment.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a printing medium according to an embodiment of the invention;

FIG. 2 illustrates a software system according to an embodiment of the invention;

FIG. 3 illustrates a process for creating customized writing instruments according to an embodiment of the invention;

FIG. 4 illustrates a customized writing instrument resulting from the process followed in FIG. 3;

FIG. 5 illustrates exemplary uses of the customized writing instruments according to an embodiment of the invention; and

FIG. 6 illustrates the customized writing instruments being used as a bookmark.

### DETAILED DESCRIPTION OF EMBODIMENTS

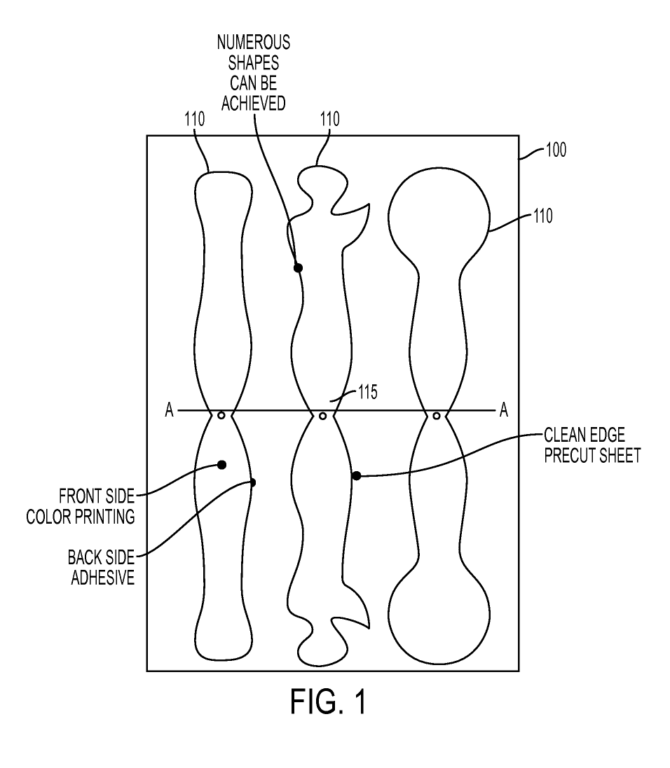

Further features and advantages of the invention, as well as the structure and operation of various embodiments of the invention, are described in detail below with reference to the accompanying FIGS. 1-6, wherein like reference numerals refer to like elements. Although the invention is described in the context of writing instruments, the inventive concepts can be implemented to manufacture other customized printable items such as, but not limited magnets, paper airplanes, signs, post-it notes, boxes, ornaments, and flags.

The present invention comprises a printing medium, ink cartridges, optional magnets, and computer software. A computer and printer are required to execute the software and to print images and text on the specialized printing medium.

FIG. 1 illustrates a printing medium 100 according to an embodiment of the invention. The printing medium 100 is a physical print media comprising two layers: (1) a top layer for text and images to be printed on with the opposite side of the layer having an adhesive and (2) a bottom layer to prevent the adhesive from adhering to other objects prior to separating the top layer from the bottom layer. The two layers can be identical to those used for printable shipping labels. Techniques for manufacturing the physical print media are readily apparent to one of ordinary skill in the art. The printing medium 100 includes a number of die-cut shapes 110, each of which may be configured in any desired shape that is able to fit within the overall dimensions of the printing medium 100. However, each die-cut shape 110 comprises two identically shaped sections, which are a mirror image of one another about an axis, which is labeled as A-A in the figure. Each die-cut shape 110 includes a hole 115 in the center for receiving an ink cartridge.

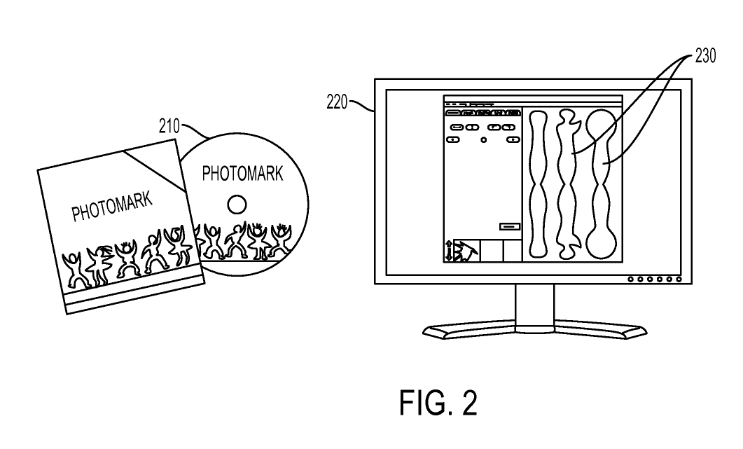

FIG. 2 illustrates a software system according to an embodiment of the invention. The software system comprises software 210 and a computer 220 (however, only the monitor of the computer is shown). The software 210 may be obtained from a compact disc (CD) or from a remote computer, e.g., Web server, if the computer 220 is connected to a network such as the Internet. Once the software 210 is installed on the computer 220, a user may use the software 210 to place artwork, text, etc. into designated display areas 230 corresponding to the die-cut shapes 110 of the printing medium 100.

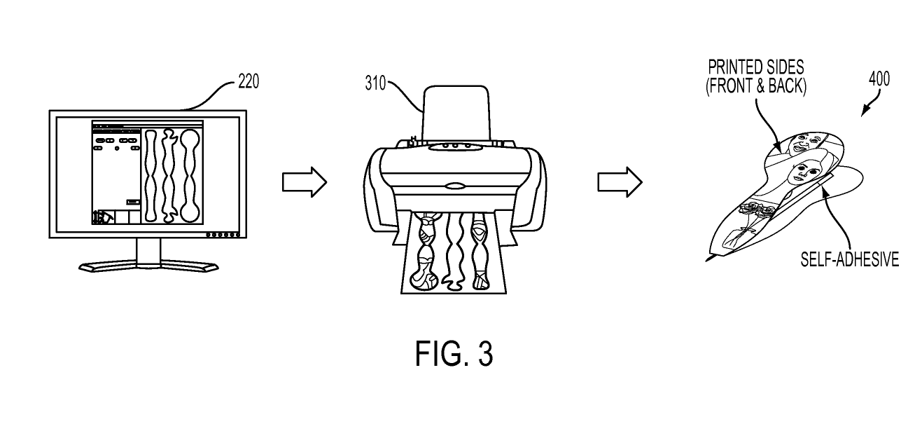

FIG. 3 illustrates a process for creating customized writing instruments according to an embodiment of the invention. Upon execution of the software 210, a user inserts images, text, artwork, etc. into the designated display areas 230. The printing medium 100 is loaded into a printer 310 and the user's images, text, artwork, etc., which was placed into the designated display areas 230, are printed on the die-cut shapes 110. The user then peels off a printed die-cut shape 110, installs the print cartridge inside and through the hole 115, and folds the die-cut shape 110 along the folding line A-A. The two sides of the die-cut shape 110 adhere to each other and cover the print cartridge, the writing tip of which protrudes through the hole 115. Optionally, a magnet may be included inside the folded and adhered die-cut shape 110 to attach the writing instrument 400 to a magnetized surface such as a refrigerator.

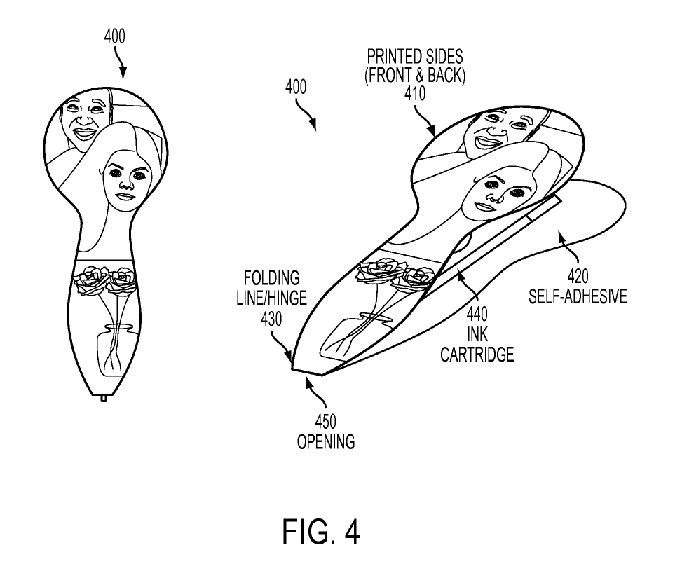

FIG. 4 illustrates a customized writing instrument 400 resulting from the process followed in FIG. 3. The writing instrument 400 comprises printed front and back sides 410, an adhesive 420 on the inner surfaces of the sides 410, a folding line/hinge 430 corresponding to the axis A-A described above, an ink cartridge 440, and an opening 450. An optional magnet (not shown) may be included inside the writing instrument 400.

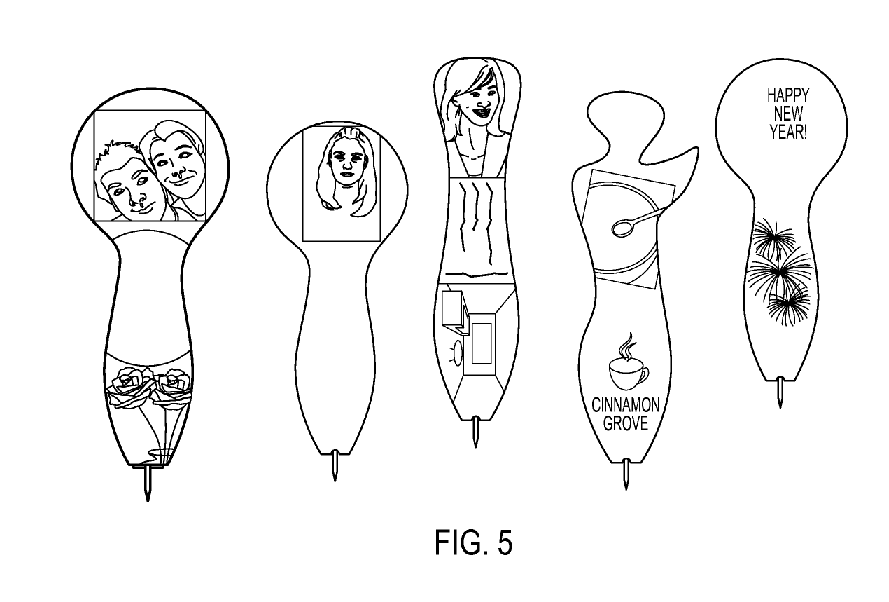

FIG. 5 illustrates exemplary uses of the customized writing instruments 400, including announcements, invitations, promotional listings, small business advertisements, and reminding friends of good times.

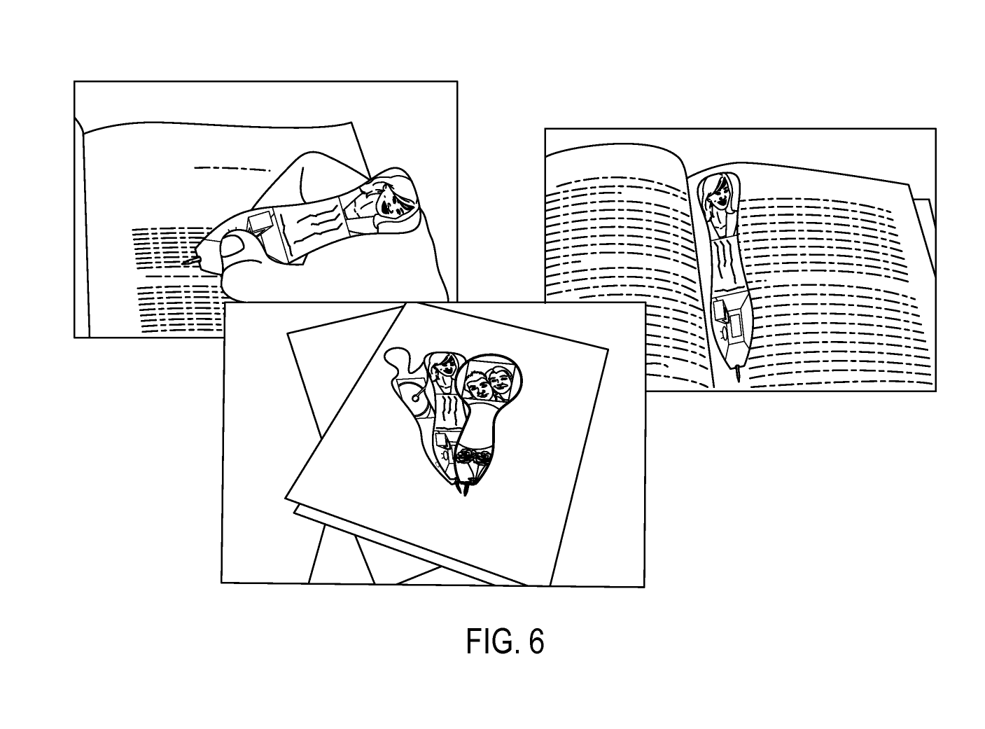

FIG. 6 illustrates the customized writing instruments 400 for use as a bookmark, where the writing instruments save the page and allow writing into the book.

In an embodiment of the invention, the die-cut shapes 110 can be shaped and configured with multiple folding lines in such a way to make three-dimensional shapes (as opposed to a two dimensional shape). For example, the die-cut shapes 110 can be used to make customized three-dimensional Christmas tree ornaments.

In another embodiment of the invention, the die-cut shapes 110 can include die cut lines, so that a printed sleeve can be created to fit around, for example, coffee cups, cell phones, beer cans, foam cups, and books.

In yet another embodiment of the invention, the die-cut shapes 110 can be configured to produce a small box with customized images on the outside. The box can used to enclose any small items, and it can house a small speaker. Such a box may have perforations to allow sounds to come through.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A printed medium comprising:
a printed top layer configured to receive text or images on a first side and an adhesive on a second side;
a removable bottom layer, wherein the printed top layer comprises one or more die-cut shapes, each die-cut shape including a first section and a second section, wherein the first section and second section are mirror images of one another about an axis; and
an opening located on the axis configured to receive an ink cartridge.

2. The printed medium of claim 1, further comprising a magnet in the printed top layer.

3. The printed medium of claim 1, wherein the printed top layer comprises announcements, invitations, promotional listings, small business advertisements, or reminding friends of good times.

4. The printed medium of claim 1, wherein the printed top layer forms a two dimensional shape.

5. The printed medium of claim 1, wherein the printed top layer forms a three dimensional shape.

6. The printed medium of claim 5, wherein the three dimensional shape comprises a box or tree.

7. The printed medium of claim 1, wherein the printed top layer forms a printed sleeve.

8. The printed medium of claim 1, wherein an image is printed on the printed top layer using software and a printer.

9. A writing device comprising:
an ink cartridge including a writing tip; and
a folded piece of pre-cut paper covering and adhering to a portion of the ink cartridge, wherein the folded piece of paper of includes an opening along a fold line, and the writing tip protrudes through the opening.

10. The writing device of claim 9, further comprising a magnet within the folded piece of pre-cut paper.

11. The writing device of claim 9, wherein the folded piece of pre-cut paper comprises announcements, invitations, promotional listings, small business advertisements, or reminding friends of good times.

12. The writing device of claim 9, wherein the folded piece of pre-cut paper forms a two dimensional shape.

13. The writing device of claim 9, wherein the folded piece of pre-cut paper forms a three dimensional shape.

14. The writing device of claim 13, wherein the three dimensional shape comprises a box or tree.

15. The writing device of claim 9, wherein the folded piece of pre-cut paper forms a printed sleeve.

16. The writing device of claim 9, wherein an image is printed on the folded piece of pre-cut paper using software and a printer.

17. A method comprising:
providing an ink cartridge including a writing tip;
folding a piece of pre-cut paper covering and adhering to a portion of the ink cartridge, wherein the folded piece of paper of includes an opening along a fold line; and
protruding the writing tip through the opening.
